(19) United States
(12) Patent Application Publication
(10) Pub. No.: US 2015/0373308 A1
(43) Pub. Date: Dec. 24, 2015

(54) REAL-TIME MOBILE VIDEO REPORTING DEVICE

(71) Applicant: Jimmy I-Hong Chen, Taipei City (TW)

(72) Inventor: Jimmy I-Hong Chen, Taipei City (TW)

(21) Appl. No.: 14/705,992

(22) Filed: May 7, 2015

(30) Foreign Application Priority Data
Jun. 19, 2014 (TW) 103210814

(51) Int. Cl. H04N 7/18; H04N 5/77; H04N 5/28; H04W 76/00

(52) U.S. Cl. CPC H04N 7/183; H04W 76/007; H04N 5/772; H04N 5/28

(57) ABSTRACT

A real-time mobile video reporting device installed to a motor vehicle and electrically connected to an automobile power supply includes a casing, a printed circuit board, a camera, a central processing unit, a memory, a control key and a mobile network connection module. The printed circuit board contains the camera, central processing unit, memory, control key and mobile network connection module, and the printed circuit board is disposed in the casing, such that the camera and the control key are disposed on a surface of the casing. When there is an accident, the control key may be pressed to record the scene of the accident by a video method and transmit the scene to an emergency remote reporting data center or a non-emergency remote reporting data center and car owner via a mobile wireless transmission technology, so as to report an accident quickly and prevent crime effectively.

### CROSS-REFERENCE TO RELATED APPLICATIONS

This non-provisional application claims priority under 35 U.S.C. §119(a) on Patent Application No(s). 103210814 filed in Taiwan, R.O.C. on Jun. 19, 2014, the entire contents of which are hereby incorporated by reference.

### BACKGROUND OF THE INVENTION

1. Field of the Invention

The present invention relates to the field of wireless communication reporting devices, and more particularly to a real-time mobile video reporting device that transmits the current situation of a car accident to a remote reporting data center such as a police reporting system or an insurance claim reporting system and a car owner via a mobile wireless network by a video method, so as to complete the reporting of an accident and achieve the crime prevention effect.

2. Description of the Related Art

At present, a vast majority of driving recorders use a camera together with a storage medium to record the driving situation continuously, and the driving recorders are externally added and generally mounted into a motor vehicle, and a lens of the camera is aligned towards the outside of a motor vehicle to capture video images, and the recorded image data may be used as an evidence for restoring the scene of a car accident. At present, car accidents are usually handled in the following manner. After an accident is reported, a traffic police comes over to the scene of the accident to take measurements and records, and the images captured by the driving recorder are used for reconstructing the scene of the accident, and finally an accident forensic unit determines the responsible party of the car accident.

However, most driving recorders of this sort are just used for monitoring road conditions only and lack of the real time transmission and reporting function, so that the driving recorders are still passive and just be used for reconstructing the scene of an accident after the accident occurs. Furthermore, the present driving recorders generally use the original power supply of the motor vehicle, so that when a motor vehicle stops and remains still, the power supply will be disconnected and images are not recorded continuously anymore. Obviously, such driving recorder cannot be used as a crime prevention or video monitoring system. At present, some driving recorders are connected to an external power supply and combined with various types of sensors to serve as a crime prevention or video monitoring system when a motor vehicle is started. If any of these sensors detects an environmental change such as an improper vibration of a motor vehicle, a vibration caused by breaking a piece of glass (such as the windshield or window of a car, or an abnormal circuit caused by breaking a lock of a motor vehicle), the camera will be triggered to take video. Since these driving recorders do not come with a real time transmission function or an immediate reporting function, the crime prevention function cannot be achieved effectively.

In addition, there is a crime tracking and prevention system combined with a global positioning system (GPS). Although such system can provide the crime prevention function, thefts cannot be stopped actively.

In view of the aforementioned drawbacks of the conventional driving recorders, the inventor of the present invention based on years of experience in the related industry to conduct extensive researches and experiments, and finally designed and developed a real-time mobile video reporting system in accordance with the present invention, so that when a car accident occurs, the current situation can be sent to a police reporting system or a non-emergency remote reporting data center immediately by a video method, so as to help reconstructing the scene of the accident and avoid the embarrassing situation of unable to report the situation once the driving recorder is damaged by unauthorized persons. The present invention also provides the crime prevention function and achieves the monitoring and reporting functions which cannot be integrated in the conventional driving recorders.

### SUMMARY OF THE INVENTION

Therefore, it is a primary objective of the present invention to provide a real-time mobile video reporting device comprising a mobile network connection module for transmitting audio/video data of a car accident to a remote reporting data center by a wireless network communication method to achieve the immediate reporting effect and protect the safety of related parties.

Another objective of the present invention is to provide a real-time mobile video reporting device combined with a backup power supply and a vibration sensor to serve for the purpose of crime prevention and audio/video data of a theft are sent to a remote reporting data center to achieve the immediate reporting and effective crime prevention effects.

To achieve the aforementioned and other objectives, the present invention provides a real-time mobile video reporting device installed to a motor vehicle, and electrically coupled to an automobile power supply, comprising: a casing; a printed circuit board, contained in the casing, and electrically coupled to the automobile power supply; a camera, installed on a surface of the casing, for capturing an image signal outside the motor vehicle; a central processing unit, installed on the printed circuit board, and electrically coupled to the camera, for processing the image signal to form digital image data; a memory, installed on the printed circuit board, electrically coupled to the central processing unit, for temporarily storing the digital image data; at least one control key, electrically coupled to the central processing unit and the camera; and a mobile network connection module, installed on the printed circuit board, and electrically coupled to the central processing unit, and connected to a remote reporting data center via a signal by a wireless network signal connection technology; such that after the control key is pressed, the camera immediately captures a current image signal outside the motor vehicle, and stores the current image signal into the memory, and after the central processing unit converts the current image signal into digital image data, the mobile network connection module transmits the digital image data to the remote reporting data center for the purpose of reporting.

In a preferred embodiment of the present invention, the real-time mobile video reporting device further comprises a global time synchronization module electrically coupled to the memory and the mobile network connection module, and synchronized with the mobile network connection module to generate time data, and the time data are transmitted by the mobile network connection module to the remote reporting data center to confirm the actual time of the occurrence of the accident and assure the authenticity and integrity of the data. In addition, the real-time mobile video reporting device further comprises a microphone electrically coupled to the memory and provided for recording a sound signal, and the central processing unit converts the sound signal into digital sound data, and the digital sound data are transmitted by the mobile network connection module to the remote reporting data center. The microphone can record the content of the current conversation. In addition, the mobile video reporting device further comprises a global positioning system module installed on the printed circuit board and electrically coupled to the memory and the mobile network connection module, for generating GPS data after the control key is pressed, and the mobile network connection module transmitting the GPS data to the remote reporting data center, so as to confirm the exact location of the scene of the accident.

Wherein, the other control key is also installed on the surface of the casing and electrically coupled to the mobile network connection module, and connected to the other remote reporting data center via a signal by a wireless connection technology.

In another preferred embodiment of the present invention, the real-time mobile video reporting device further comprises a backup power supply installed on the printed circuit board for supplying electric power when the automobile power supply does not supply electric power. In addition, the real-time mobile video reporting device further comprises a vibration sensor installed on the printed circuit board and electrically coupled to the backup power supply, such that the camera will be turned on to start recording automatically whenever there is an improper vibration, and the mobile network connection module transmits the digital image data to the remote reporting data center.

In addition, the surface of the casing has a signal port electrically coupled to the memory and provided for electrically connecting to a display to display the digital image data. When the real-time mobile video reporting device is not in use, the device may be electrically disconnected from the display to achieve the effect of reducing power consumption.

### BRIEF DESCRIPTION OF THE DRAWINGS

FIG. 1 is a front view of a preferred embodiment of the present invention;

FIG. 2 is a rear view of a preferred embodiment of the present invention;

FIG. 3 is a schematic view of the installation of a preferred embodiment of the present invention; and

FIG. 4 is a flow chart of the operation of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

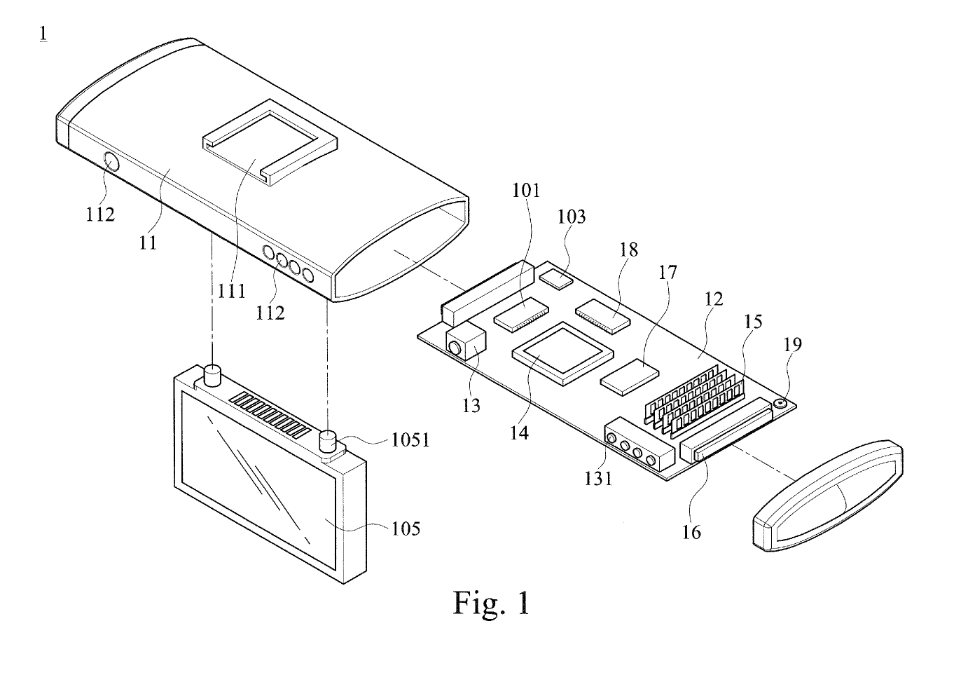

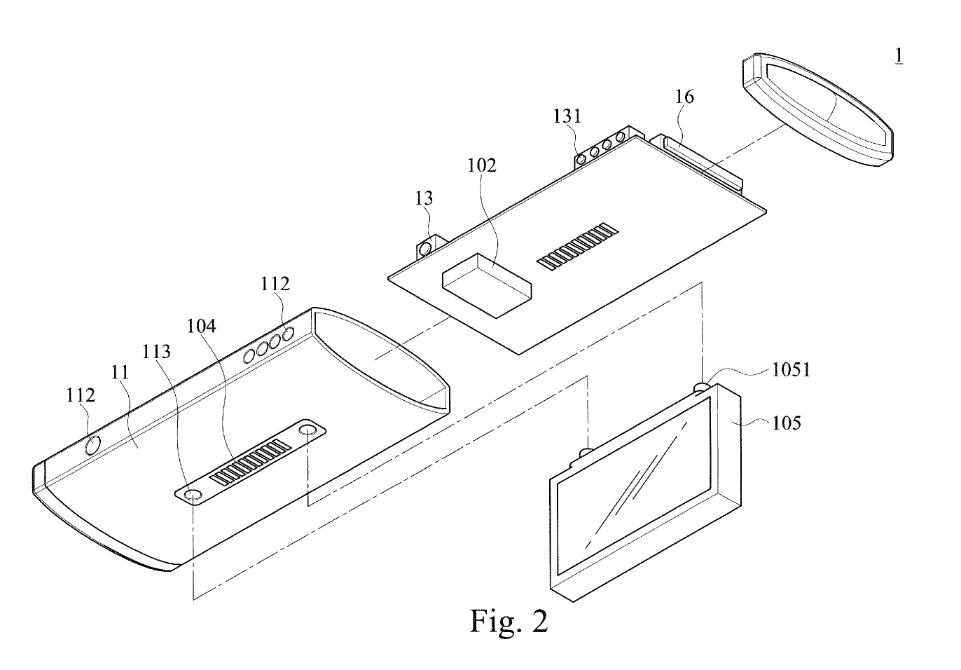

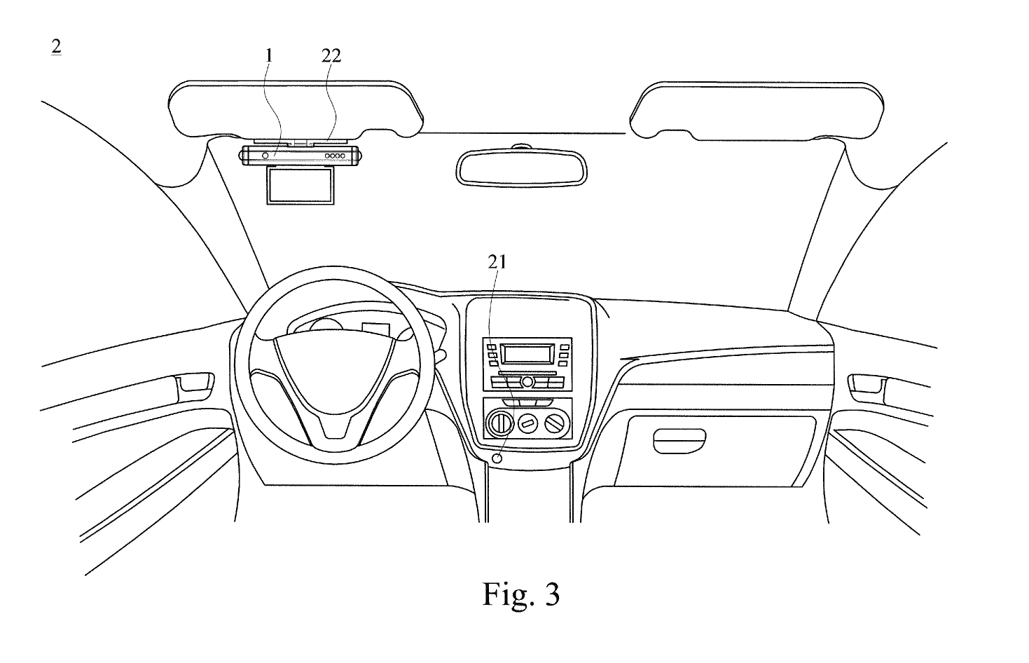

With reference to FIGS. 1 to 3 for the front view and the rear view of a real-time mobile video reporting device and the schematic view of installing the real-time mobile video reporting device in accordance with a preferred embodiment of the present invention respectively, the real-time mobile video reporting device 1 is installed to a motor vehicle 2 and electrically coupled to an automobile power supply 21. The real-time mobile video reporting device 1 comprises a casing 11, a printed circuit board 12, a camera 13, a central processing unit 14, a memory 15, a pair of control keys 16 and a mobile network connection module 17.

The casing 11 is a long flat structure having a containing space formed in the casing 11, a snap-in slot formed at the top of the casing 11 for snapping and fixing into a mounting bracket 22 inside the motor vehicle 2. In addition, the casing 11 has a plurality of through holes 112 formed on a surface of the casing 11.

The printed circuit board 12 is contained in the casing 11 and plugged into a cigarette lighter socket of the motor vehicle 2 through a power cable in order to be electrically coupled to the automobile power supply 21.

The camera 13 is passed through and out of a through hole formed on a surface of the casing for capturing an image signal outside the motor vehicle 2, and the camera 13 has a plurality of LED fill lights 131 installed on a side of the camera 113 to provide a photographic fill light function for nighttime or dark places.

The central processing unit 14 is installed on the printed circuit board 12 and electrically coupled to the camera 13 for computing and processing the image signal to generate digital image data.

The memory 15 is installed on the printed circuit board 12 and electrically coupled to the central processing unit 14 for temporarily storing the digital image data. It is noteworthy that the memory 15 may also serve as a buffer space for the data transmission in addition to the buffering function provided when the central processing unit 14 is operated, and the present invention does not have any storage space of a storage device such as a memory card or a flash drive for storing the digital image data permanently. However, users may add such storage device to store the originally converted data image data, if needed.

The pair of control keys 16 are installed on surfaces on both sides of the casing 11 respectively and electrically coupled to the central processing unit 14 and the camera 13. The control keys 16 may be operated to drive the central processing unit 14 and the camera 13.

The mobile network connection module 17 is also installed on the printed circuit board 12 and electrically coupled to the central processing unit 14 and connected to an emergency remote reporting data center (such as a police report system) or a non-emergency remote reporting data center (such as an insurance claim system or a cloud storage space) through such as 2G, 3G, 3.5G and 4G signal of a wireless network connection technology. In general, one of the control keys 16 is connected to the emergency remote reporting data center and the other one is connected to the non-emergency remote reporting data center, and the control keys 16 are distinguished by colors. For example, after one of the control keys 16 is pressed, the camera 13 immediately captures the image signal of the current situation outside a motor vehicle and stores the image signal in the memory 15. After the central processing unit 14 converts the image signal into the digital image data, the mobile network connection module 17 transmits the digital image data to the emergency remote reporting data center for the purpose of reporting.

In addition, the real-time mobile video reporting device 1 of the present invention further comprises a global time synchronization module 18 electrically coupled to the memory 15 and the mobile network connection module 17. After connecting to a global time synchronization system through the mobile network connection module 17, the real-time mobile video reporting device 1 is synchronized to generate time data, and then the time data are transmitted to the emergency remote reporting data center and/or the non-emergency remote reporting data center through the mobile network connection module 17 to confirm the occurrence of the accident and assure the authenticity and integrity of the data.

In addition, the real-time mobile video reporting device 1 further comprises a microphone 19 electrically coupled to the memory 15 for recording a sound signal, and the central processing unit 14 converts the sound signal into digital sound data, and both digital sound data and digital image data are simultaneously transmitted to the emergency remote reporting data center and/or the non-emergency remote reporting data center through the mobile network connection module 17. The microphone 19 may record the conversation taken at the time of the accident; of course, it may also be a waterproof microphone installed outside the motor vehicle 2 to protect the safety of the related parties.

The mobile video reporting device 1 further comprises a global positioning system module 101 installed on the printed circuit board 12 and electrically coupled to the memory 15 and the mobile network connection module 17. After each control key 16 is pressed, GPS data are generated and transmitted to the emergency remote reporting data center and/or the non-emergency remote reporting data center through the mobile network connection module 17 to assure the location of the accident and assist related persons to reach the location and handle the accident quickly.

To add the crime prevention function, the real-time mobile video reporting device 1 of the present invention further comprises a backup power supply 102 installed on the printed circuit board 12 for supplying electric power whenever the automobile power supply 21 does not supply power. In addition, the real-time mobile video reporting device 1 further comprises a vibration sensor 103 installed on the printed circuit board 12 and electrically coupled to the backup power supply 102. If there is an improper vibration, the camera 13 will be turned on to start recording and transmit the digital image data to the emergency remote reporting data center and/or the non-emergency remote reporting data center through the mobile network connection module.

To facilitate users to view the recorded digital image data directly, the present invention further comprises a signal port 104 formed on a surface of the casing 11 and electrically coupled to the memory 15, and the signal port 104 is electrically coupled to a display 105 for displaying the digital image data. it is noteworthy that the surfaces of the casing 11 on both sides of the signal port 104 have two fixing holes 113, and the display 105 has two latching columns 1051 configured to be corresponsive to the two fixing holes 113 respectively.

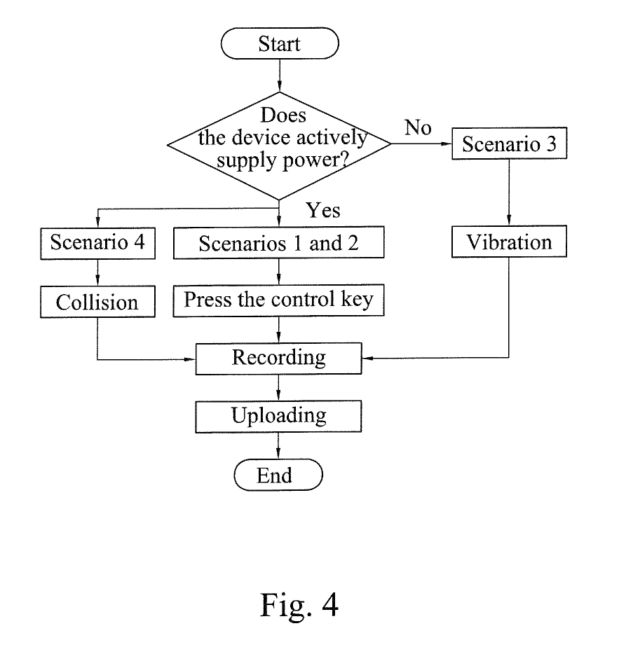

With reference to FIG. 4 for the flow chart of a preferred embodiment of the present invention, the following scenarios are used for preferred embodiments. Scenario 1: For an emergency (or ask-for-help) situation, a user may press a red control key 16 twice, and then the real-time mobile video reporting device 1 will automatically send out the GPS data and the digital image data obtained from the previous minute to the next minute of the occurrence of an accident, and the time data are embedded into the digital image data. The mobile network connection module 17 transmits the data to the emergency remote reporting data center and/or the non-emergency remote reporting data center, while providing an instant screen to rescue personnel through a remote online connection. Scenario 2: For reporting a non-emergency situation, a user may press a blue control key twice to confirm the reporting, and the real-time mobile video reporting device 1 will automatically send out the GPS data and the digital image data and the time data collected from the previous minute to the next minute of the occurrence of the accident, and the mobile network connection module 17 is provided for storing the data into a remote storage system such as DROPBOX, GOOGLE DRIVE or iCLOUD. Scenario 3: For the situation without supplying power actively by the automobile power supply 21, the real-time mobile video reporting device 1 of the present invention may use a built-in backup power supply 102. If the vibration sensor 103 is triggered, the camera will automatically capture image signals and transmit the digital image data to a remote storage system, or notify related personnel or centers by SMS message through a preset mobile phone number. Wherein, the digital image data include video screens captured a minute after the device is turned on, and the digital image data are transmitted for three times with a total of three-minute video screens. Scenario 4: When the motor vehicle 2 is traveling (while the automobile power supply 21 is being used) and collided seriously, the real-time mobile video reporting device 1 of the present invention will be triggered through the vibration sensor 103, and then the digital image data are captured immediately, and the mobile network connection module 17 automatically sends out the GPS data and the digital image data to the emergency remote reporting data center for the purposes of reporting and rescue.

What is claimed is:

1. A real-time mobile video reporting device, installed to a motor vehicle, and electrically coupled to an automobile power supply, comprising:
a casing;
a printed circuit board, contained in the casing, and electrically coupled to the automobile power supply;
a camera, installed on a surface of the casing, for capturing an image signal outside the motor vehicle;
a central processing unit, installed on the printed circuit board, and electrically coupled to the camera, for processing the image signal to form a digital image data;
a memory, installed on the printed circuit board, electrically coupled to the central processing unit, for temporarily storing the digital image data;
at least one control key, electrically coupled to the central processing unit and the camera; and
a mobile network connection module, installed on the printed circuit board, and electrically coupled to the central processing unit, and connected to a remote reporting data center via a signal by a wireless network signal connection technology; thereby, after the control key is pressed, the camera immediately captures a current image signal outside the motor vehicle, and stores the current image signal into the memory, and after the central processing unit converts the current image signal into digital image data, the mobile network connection module transmits the digital image data to the remote reporting data center for the purpose of reporting.

2. The real-time mobile video reporting device as claimed in claim 1, further comprising a global time synchronization module electrically coupled to the memory and the mobile network connection module, and synchronized with the mobile network connection module to generate a time data, and the time data being transmitted by the mobile network connection module to the remote reporting data center.

3. The real-time mobile video reporting device as claimed in claim 1, further comprising a microphone electrically coupled to the memory and provided for recording a sound signal, and the central processing unit converting the sound signal into a digital sound data, and the digital sound data being transmitted by the mobile network connection module to the remote reporting data center.

4. The real-time mobile video reporting device as claimed in claim 3, further comprising a global positioning system module installed on the printed circuit board and electrically coupled to the memory and the mobile network connection module, for generating a GPS data after the control key is pressed, and the mobile network connection module transmitting the GPS data to the remote reporting data center.

5. The real-time mobile video reporting device as claimed in claim 4, wherein an another control key is also installed on the surface of the casing and electrically coupled to the mobile network connection module, and connected to the remote reporting data center via a signal by a wireless connection technology.

6. The real-time mobile video reporting device as claimed in claim 5, further comprising a backup power supply installed on the printed circuit board for supplying electric power when the automobile power supply does not supply electric power.

7. The real-time mobile video reporting device as claimed in claim 6, further comprising a vibration sensor installed on the printed circuit board and electrically coupled to the backup power supply, such that the camera will be turned on to start recording automatically whenever there is an improper vibration, and the mobile network connection module transmits the digital image data to the remote reporting data center.

8. The real-time mobile video reporting device as claimed in claim 7, wherein the surface of the casing has a signal port electrically coupled to the memory and provided for electrically connecting to a display to display the digital image data.

9. The real-time mobile video reporting device as claimed in claim 2, further comprising a microphone electrically coupled to the memory and provided for recording a sound signal, and the central processing unit converting the sound signal into digital sound data, and the digital sound data being transmitted by the mobile network connection module to the remote reporting data center.

10. The real-time mobile video reporting device as claimed in claim 9, further comprising a global positioning system module installed on the printed circuit board and electrically coupled to the memory and the mobile network connection module, for generating a GPS data after the control key is pressed, and the mobile network connection module transmitting the GPS data to the remote reporting data center.

11. The real-time mobile video reporting device as claimed in claim 10, wherein an another control key is also installed on the surface of the casing and electrically coupled to the mobile network connection module, and connected to the remote reporting data center via a signal by a wireless connection technology.

12. The real-time mobile video reporting device as claimed in claim 11, further comprising a backup power supply installed on the printed circuit board for supplying electric power when the automobile power supply does not supply electric power.

13. The real-time mobile video reporting device as claimed in claim 12, further comprising a vibration sensor installed on the printed circuit board and electrically coupled to the backup power supply, such that the camera will be turned on to start recording automatically whenever there is an improper vibration, and the mobile network connection module transmits the digital image data to the remote reporting data center.

14. The real-time mobile video reporting device as claimed in claim 13, wherein the surface of the casing has a signal port electrically coupled to the memory and provided for electrically connecting to a display to display the digital image data.
